(19) United States
(12) Patent Application Publication
(10) Pub. No.: US 2005/0091097 A1
(43) Pub. Date: Apr. 28, 2005

(54) Property Value Map System

(76) Inventor: Jose De Sousa, Naples, FL (US)

Correspondence Address: Jose De Sousa, P. O. Box 111585, Naples, FL, 34108, US

(21) Appl. No.: 10/904,075

(22) Filed: Oct. 21, 2004

(51) Int. Cl. G06F 17/60

(52) U.S. Cl. 705/8

(57) ABSTRACT

A property value map system where one can check the value of the property as well as the history of said property and the surrounding neighborhood property values and history. Surrounding commerce, recreational, schools, services, etc.

A map system used to record, display information on real estate values in a map format with the history of said property and surrounding property values. Recording any property damages related to insurance claims or any property improvement. Additional information of surrounding neighborhood such as schools, recreational areas, stores, police departments, hospitals, fire departments, Churches, etc.

Users of said services may access this information via the internet, software, paper or any other media currently used to obtain information or any other future media translating devices or apparatus.

1. I claim a map system which maps real estate property which informs the current value of said property and history value on said property the map also shows value of surrounding real estate property additional information of surrounding neighborhood such as schools, recreational areas, stores, police departments, hospitals, fire departments, Churches, etc users of said map system may access this information via the internet, software, paper or any other media currently used to obtain information or any future media translating devices or apparatus.
